(19) United States
(12) Patent Application Publication
(10) Pub. No.: US 2026/0153784 A1
(43) Pub. Date: Jun. 4, 2026

(54) OPTICAL SYSTEM

(71) Applicant: TDK TAIWAN CORP., Taoyuan City (TW)

(72) Inventors: Kai-Po FAN, Taoyuan City (TW); Man-Ting LU, Taoyuan City (TW); Yu-Che KAO, Taoyuan City (TW); Shou-Jen LIU, Taoyuan City (TW)

(21) Appl. No.: 19/183,388

(22) Filed: Apr. 18, 2025

Related U.S. Application Data
(60) Provisional application No. 63/636,417, filed on Apr. 19, 2024.

(51) Int. Cl. G03B 9/06; G03B 17/12

(52) U.S. Cl. CPC G03B 9/06; G03B 17/12

(57) ABSTRACT

An optical system is provided, including a first module and a second module. The first module is configured to hold a first optical unit that has an optical axis. The second module is connected to the first module. The second module has a main body and a circuit board, wherein the main body is configured to hold a second optical unit, and the circuit board is connected between the main body and the first module.

### CROSS REFERENCE TO RELATED APPLICATIONS

This application claims the benefit of U.S. Provisional Application No. 63/636,417, filed Apr. 19, 2024, the entirety of which is incorporated by reference herein.

### BACKGROUND OF THE INVENTION

### Field of the Invention

The present invention relates to an optical system, and, in particular, it relates to an optical system having a flexible circuit board.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

In some electronic devices, several coils and corresponding magnets are used for adjusting the focus of a lens. However, miniaturization of these electronic devices may increase the difficulty of mechanical design, and it may also make the optical system less reliable and stable. Therefore, addressing the aforementioned problems has become a challenge.

### BRIEF SUMMARY OF THE INVENTION

An embodiment of the present invention provides an optical system. The optical system includes a first module and a second module. The first module is configured to hold a first optical unit that has an optical axis. The second module is connected to the first module and has a main body and a circuit board, wherein the main body is configured to hold a second optical unit, and the circuit board is connected between the main body and the first module.

In some embodiments, the first module has a housing and a holder, and the first optical unit is disposed on the holder, wherein the holder and the first optical unit are movably disposed in an accommodating space formed by the housing.

### BRIEF DESCRIPTION OF THE DRAWINGS

The present invention can be more fully understood by reading the subsequent detailed description and examples with references made to the accompanying drawings, wherein:

FIG. 1 is an exploded diagram of an optical system 100 in accordance with an embodiment of the invention.

FIG. 2 is another exploded diagram of the optical system 100 in FIG. 1.

FIG. 3 is a perspective diagram of the optical system 100 in FIGS. 1 and 2 after assembly.

FIG. 4 is another perspective diagram of the optical system 100 in FIGS. 1 and 2 after assembly.

FIG. 5 is an exploded diagram of the second module 20.

FIG. 6 is a perspective diagram of the coils C, the metal substrates P, and the circuit board F after assembly.

FIG. 7 is another perspective diagram of the coils C, the metal substrates P, and the circuit board F after assembly.

FIG. 8 is a perspective diagram of the circuit board F in FIGS. 6 and 7.

FIG. 9 is a top view of the circuit board F and the main body 21 of the second module 20 after assembly.

FIG. 10 is a cross-sectional view of the optical system 100.

### DETAILED DESCRIPTION OF THE INVENTION

The making and using of the embodiments of the optical system are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

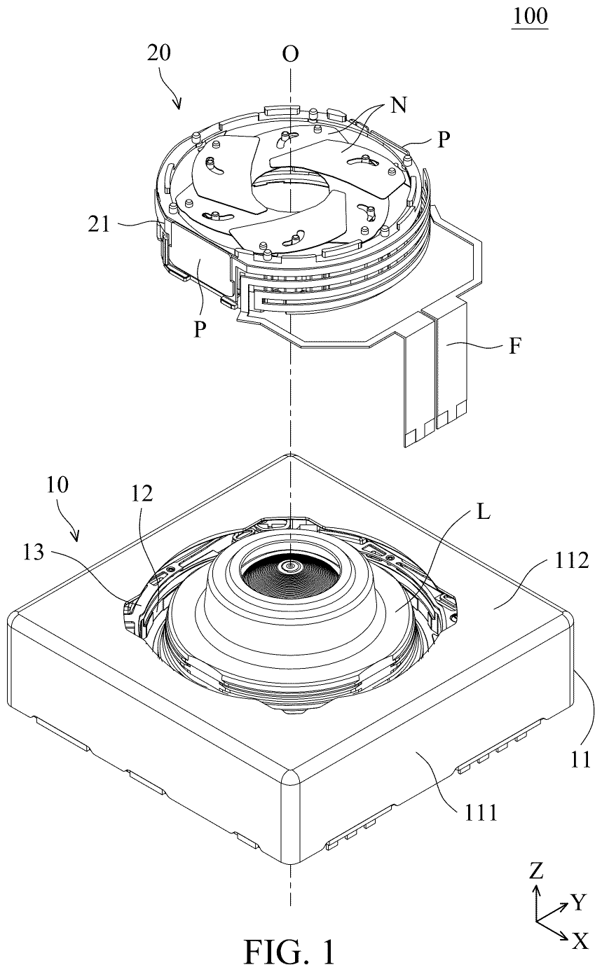

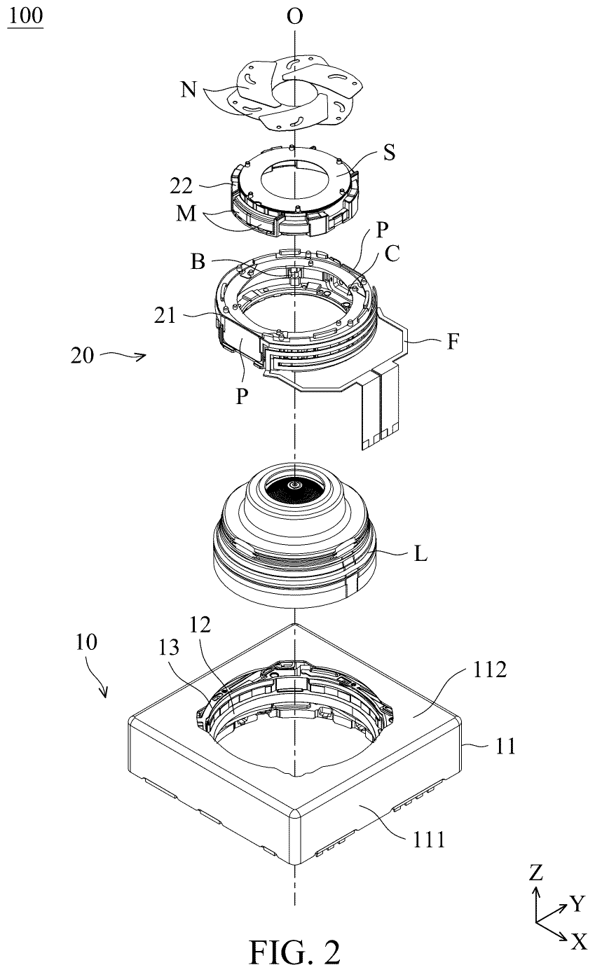

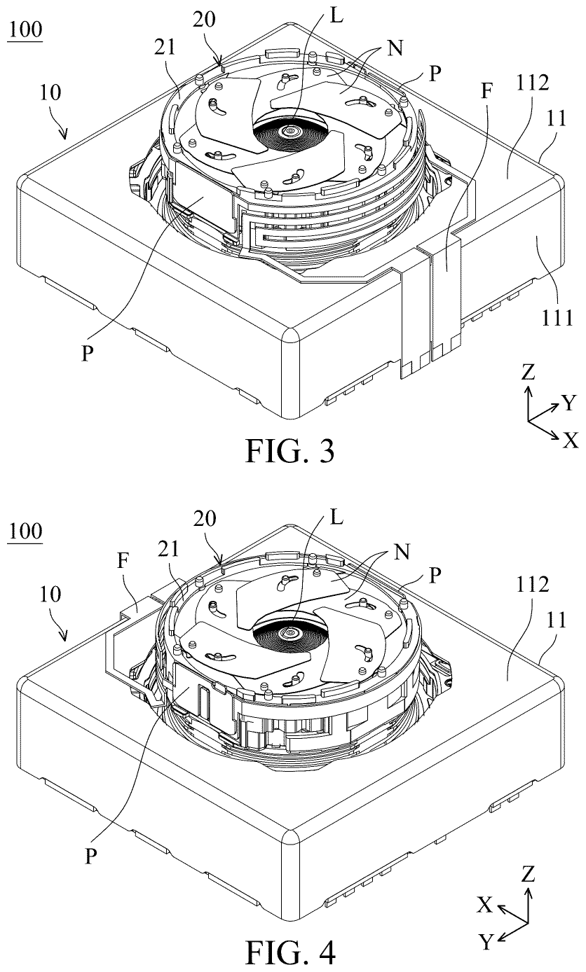

FIG. 1 is an exploded diagram of an optical system 100 in accordance with an embodiment of the invention. FIG. 2 is another exploded diagram of the optical system 100 in FIG. 1. FIG. 3 is a perspective diagram of the optical system 100 in FIGS. 1 and 2 after assembly. FIG. 3 is another perspective diagram of the optical system 100 in FIGS. 1 and 2 after assembly. FIG. 5 is an exploded diagram of the second module 20.

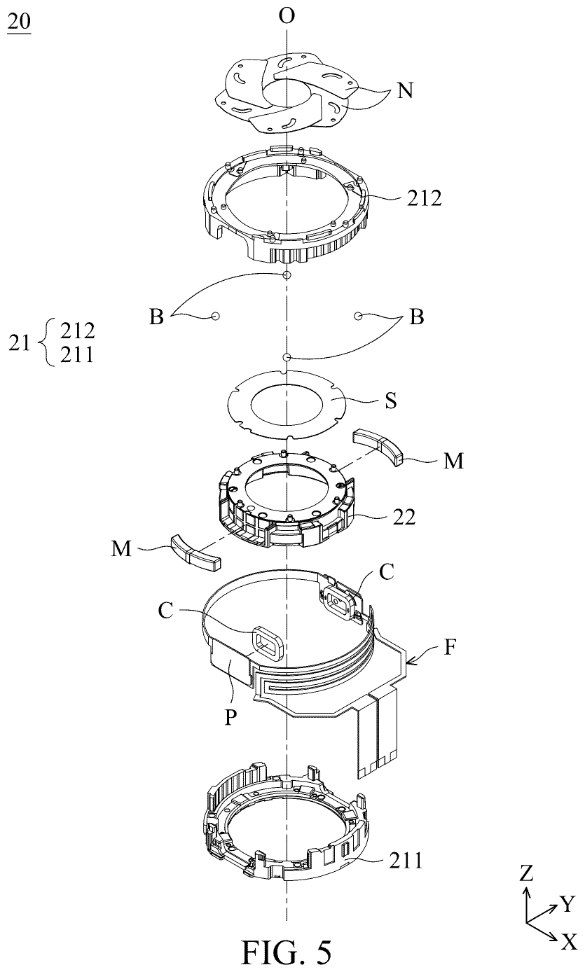

As shown in FIGS. 1-5, the optical system 100 in this embodiment may be disposed in a cell phone or other portable electronic device. The optical system 100 primarily includes a first module 10 and a second module 20. The first module 10 comprises a Voice Coil Motor (VCM) and a first optical unit L disposed in the VCM. The VCM is configured to drive the first optical unit L to move, thereby achieving the function of Auto-Focusing (AF) or Optical Image Stabilization (OIS).

The second module 20 is disposed on the top side of the first module 10, and a second optical unit N is disposed on the top side of the second module 20. In this embodiment, the first optical unit L includes at least an optical lens. The second optical unit N includes several aperture blades for adjusting the size of the aperture opening through which light passes to enter the camera.

It can be seen in FIGS. 1-4 that the first module 10 has a plastic housing 11, a holder 12, and a resilient element 13, wherein the first optical unit L is disposed in the holder 12. The resilient element 13 may comprise metal sheet spring movably connected between the housing 11 and the holder 12.

Additionally, FIGS. 2 and 5 show that the second module 20 includes a main body 21, a movable part 22, a light shading sheet S, and a circuit board F. The light shading sheet S is disposed on the movable part 22, and the main body 21 is formed by a lower frame 211 and an upper f frame 212. During assembly, the lower frame 212 is adhered to the first optical unit L in the first module 10. Specifically, at least a roller B is disposed between the main body 21 and the movable part 22, whereby the movable part 22 can be guided to rotate relative to the main body 21 around the optical axis O.

It should be noted that the circuit board F may be a flexible printed circuit board (FPC). At least a coil C is disposed on the inner sider of the circuit board F, and at least a metal substrate P is disposed on the outer sider of the circuit board F. Moreover, at least a magnet M is disposed on the outer side of the movable part 22 and located corresponding to the magnet M. The magnets M and the coils C constitute a driving assembly for rotating the movable part 22 relative to the main body 21 around the optical axis O.

With the second optical unit N (aperture blades) pivotally connected to the main body 21 and the movable part 22, the movable part 22 can be driven to rotate relative to the main body 21 around the optical axis O by the magnetic force generated from the coils C and the magnets M. Therefore, the size of the aperture opening can be adjusted to regulate light intake of the optical system 100.

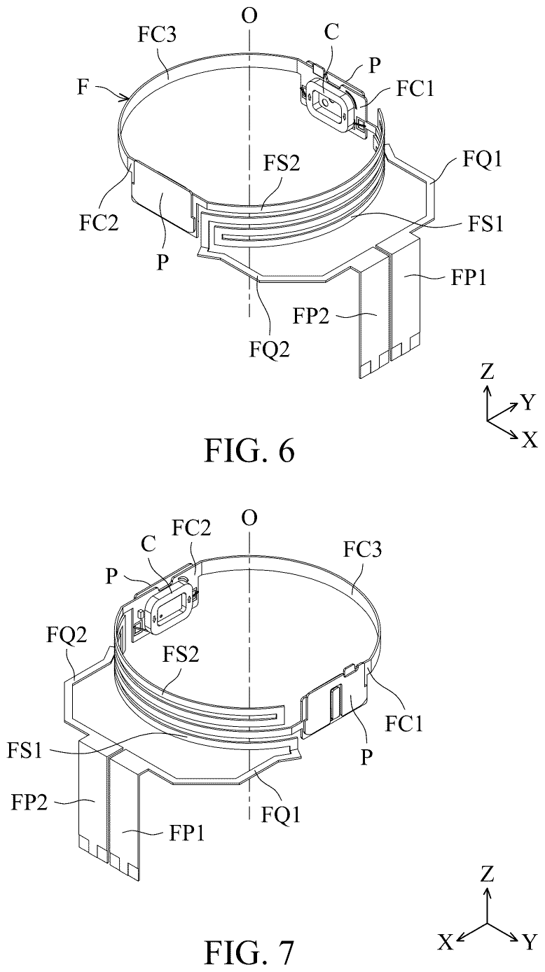

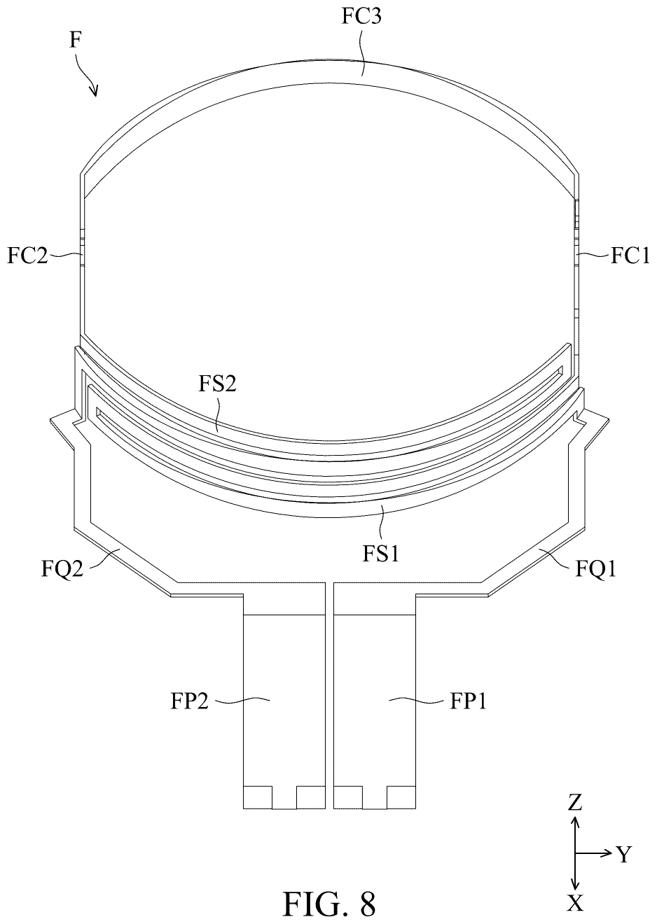

FIG. 6 is a perspective diagram of the coils C, the metal substrate P, and the circuit board F after assembly. FIG. 7 is another perspective diagram of the coils C, the metal substrate P, and the circuit board F after assembly. FIG. 8 is a perspective diagram of the circuit board F in FIGS. 6 and 7.

Referring to FIGS. 1-8, the circuit board F is disposed around the main body 21 of the second module 20. The circuit board F includes a first end portion FP1, a second end portion FP2, a first extending portion FQ1, a second extending portion FQ2, a first flexible portion FS1, a second flexible portion FS2, a first flat portion FC1, a second flat portion FC2, and a connecting portion FC3.

During assembly of the first and second modules 10 and 20, as shown in FIGS. 1-3, the first and second end portions FP1 and FP2 are adhered to the outer surface 111 of the housing 11 of the first module 10 and extend in the vertical direction (Z direction), whereby the coils C can be electrically connected to an external circuit (not shown).

Moreover, the first and second extending portions FQ1 and FQ2 substantially extend along the top surface 112 of the housing 112 for movably connecting the first and second end portions FP1 and FP2 to the first and second flexible portion FS1 and FS2, as shown in FIGS. 1-3. It should be noted that the first and second extending portions FQ1 and FQ2 are not affixed to the top surface 112 that is substantially perpendicular to the outer surface 111 of the housing 11. Here, the first and second extending portions FQ1 and FQ2 is not parallel to the first and second end portions FP1 and FP2.

The first and second flat portions FC1 and FC2 are adhered to opposite sides of the main body 21, and the coils C are disposed on the inner side of the first and second flat portions FC1 and FC2. In some embodiments, the optical system 100 may comprise only one coil C disposed on either one of the first and second flat portions FC1 and FC2. When viewed in a direction parallel to the optical axis O, the connecting portion FC3 has a curved structure extending along the peripheral of the main body 21 for electrically connecting the first flat portion FC1 to the second flat portion FC2.

In this embodiment, the first and second flexible portion FS1 and FS2 of the circuit board F are situated on the same side of the main body 21. When viewed in a direction parallel to the optical axis O, the first and second flexible portion FS1 and FS2 have a curved and meandering structure connected between the first, second flat portions FC1, FC2 and the first, second extending portions FQ1, FQ2. Specifically, the first and second flexible portion FS1 and FS2 at least partially overlap when viewed in the direction parallel to the optical axis O.

It should be noted that when the VCM in the first module 10 drives the first optical unit L and the main body 21 of the second module 20 to move relative to the housing 11 along the Z axis, the first and second flexible portion FS1 and FS2 may be forced to deform since they are not affixed to the main body 21 of the second module 20. Thus, structural damage of the circuit board F can be efficiently prevented.

In some embodiments, the damping gel may be disposed between the main body 21 and the first and second flexible portion FS1 and FS2 to improve the structural stability of the optical system 100.

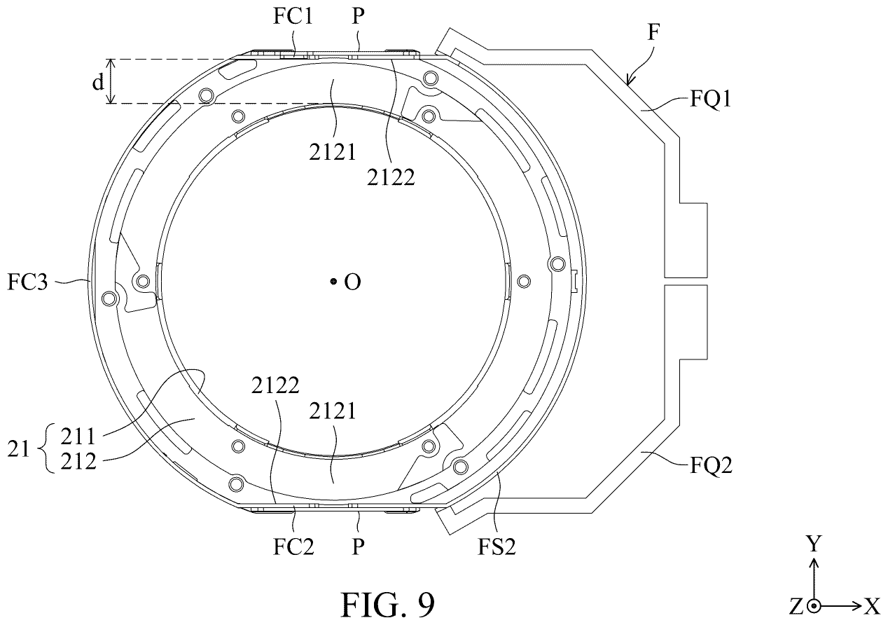

FIG. 9 is a top view of the circuit board F and the main body 21 of the second module 20 after assembly. As shown in FIGS. 5 and 9, the main body 21 of the second module 20 includes a lower frame 211 and an upper frame 212. The upper frame 212 has two narrowed portions 2121, wherein the first, second flat portions FC1, FC2 of the circuit board F are mounted on the flat surfaces 2122 of the narrowed portions 2121. It should be noted that the narrowed portions 2121 are located on opposite sides of the upper frame 212, and the flat surfaces 2122 are formed on the outer side of the narrowed portions 2121. Moreover, two metal substrates P are adhered to the outer surfaces of the first and second flat portions FC1 and FC2, whereby the first and second flat portions FC1 and FC2 can be sufficiently supported by the metal substrates P. In some embodiments, the optical system 100 may comprise only one metal substrate P disposed on either the first flat portion FC1 or the second flat portion FC2.

In this embodiment, both of the lower frame 211 and the upper frame 212 have an annular structure. The narrowed portions 2121 of the upper frame 212 has a width d that runs along the radial direction of the main body 21, wherein the width d is the minimum width of the upper frame 212 along the radial direction that is perpendicular to the optical axis O.

In some embodiments, the lower and upper frames 211 and 212 may be integrally formed in one piece, and the width d is the minimum width of the upper frame 212 along the radial direction of the main body 21.

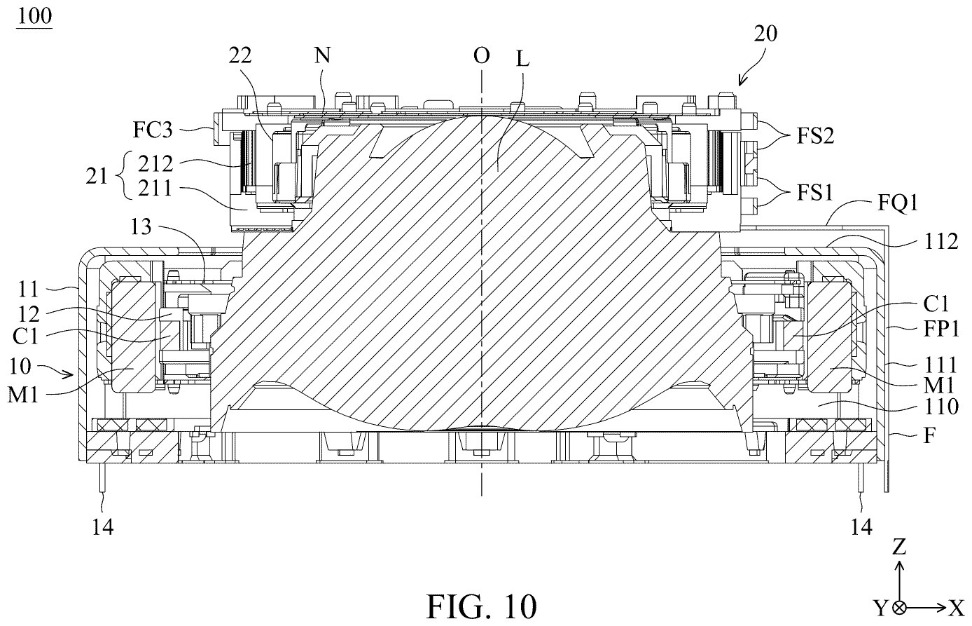

FIG. 10 is a cross-sectional view of the optical system 100. As shown in FIG. 10, the holder 12 and the first optical unit L (optical lens) are disposed in an accommodating space 110 of the housing 11 of the first module 100. It should be noted that two magnets M1 are disposed on the inner side the housing 11, and a coil C1 is disposed on the outer side of the holder 12. The coil C1 can be electrically connected to the external circuit via the conductive pins 14 under the accommodating space 110. Hence, the first optical unit L can be driven to move along the optical axis O and achieve achieving the function of Auto-Focusing (AF) or Optical Image Stabilization (OIS).

During assembly of the optical system 100, the first optical unit L in the first module 10 is adhered to the bottom surface of the main body 21. In this configuration, the first optical unit L extends into the main body 21 of the second module 20 in the Z direction, and the top portion of the first optical unit L is located close to the second optical unit N (aperture blades).

As the first and second flexible portion FS1 and FS2 are deformable when the first optical unit L moves relative to the housing 11 along the optical axis O, structural damage of the circuit board F can be efficiently prevented.

It can be seen in FIG. 10 that the outer surface 111 is located between the first optical unit L and the first and second end portions FP1 and FP2 of the circuit board F along a horizontal direction (X direction). Moreover, the top surface 112 of the housing 11 is situated between the accommodating space 110 of the housing 11 and the first and second extending portions FQ1 and FQ2 along a vertical direction (Z direction).

With the first, second extending portions FQ1, FQ2 of the circuit board F extending along the top surface 112 of the housing 11 and the first, second end portions FP1, FP2 of the circuit board F adhered to the outer surface 111 of the housing 11, the circuit board F can directly connect to the external circuit along from the outside of the housing 11, wherein the first, second end portions FP1, FP2 are located on the same side of the quadrilateral housing 11. Since the circuit board F do not extend through the accommodating space 110 in the housing 11, circuit layout inside the first module 10 can be simplified, and miniaturization of the first module 10 can also be achieved.

In summary, as the circuit board F of the invention extends from the outside of the first module 10, the coils C in the second module 20 can be electrically connected to the external circuit. In this configuration, circuit layout inside the first module 10 can be simplified, and miniaturization of the first module 10 can also be achieved. Specifically, as the first and second flexible portion FS1 and FS2 are deformable, the second module 20 can be assembled to the first modules 10 of different sizes without structural damages to the circuit board F, whereby the compatibility between the first and second modules 10 and 20 during assembly can be increased.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical system, comprising:
a first module, configured to hold a first optical unit that has an optical axis; and
a second module, connected to the first module and having a main body and a circuit board, wherein the main body is configured to hold a second optical unit, and the circuit board is connected between the main body and the first module.

2. The optical system as claimed in claim 1, wherein the first module has a housing and a holder, and the first optical unit is disposed on the holder, wherein the holder and the first optical unit are movably disposed in an accommodating space formed by the housing.

3. The optical system as claimed in claim 2, wherein the circuit board is connected to an outer surface of the housing and does not extend into the accommodating space.

4. The optical system as claimed in claim 3, wherein the circuit board surrounds the main body and has a first end portion and a second end portion affixed to the outer surface of the housing.

5. The optical system as claimed in claim 4, wherein the outer surface is situated between the accommodating space and the first and second end portions in a horizontal direction that is perpendicular to the optical axis.

6. The optical system as claimed in claim 5, wherein the circuit board further has a first extending portion and a second extending portion extending along a top surface of the housing, the first and second extending portions are respectively connected to the first and second end portions, and the top surface is situated between the accommodating space and the first and second extending portions along the optical axis.

7. The optical system as claimed in claim 6, wherein the circuit board further has a first flexible portion and a second flexible portion, the first extending portion is connected between the first end portion and the first flexible portion, and the second extending portion is connected between the second end portion and the second flexible portion.

8. The optical system as claimed in claim 7, wherein the first flexible portion and the second flexible portion both have a curved and meandering structure.

9. The optical system as claimed in claim 7, wherein the first and second flexible portions at least partially overlap when viewed along the optical axis.

10. The optical system as claimed in claim 7, further comprising a damping gel disposed between the main body and the first and second flexible portions.

11. The optical system as claimed in claim 7, wherein the circuit board further has a first flat portion and a second flat portion, the first flexible portion is connected between the first extending portion and the first flat portion, and the second flexible portion is connected between the second extending portion and the second flat portion.

12. The optical system as claimed in claim 11, wherein the circuit board further has a curved connecting portion disposed around the main body and electrically connecting the first flat portion to the second flat portion, and the connecting portion and the first and second flexible portions are located on opposite sides of the main body.

13. The optical system as claimed in claim 11, wherein the main body is in an annular shape and has two narrowed portions, each of the narrowed portions forms a flat surface, and the first and second flat portions are affixed to the flat surfaces.

14. The optical system as claimed in claim 13, wherein the narrowed portions are formed on opposite sides of the main body.

15. The optical system as claimed in claim 13, wherein at least one of the narrowed portions has a width along a radial direction of the main body, and the width is the minimum width of the main body.

16. The optical system as claimed in claim 13, further comprising a metal substrate disposed on the first flat portion or the second flat portion.

17. The optical system as claimed in claim 13, wherein the second module further has a movable part, a magnet, and a coil, the movable part is movably connected to the main body, the magnet is disposed on the movable part, and the coil is disposed on the first flat portion or the second flat portion for driving the movable part to move relative to the main body.

18. The optical system as claimed in claim 17, wherein the second module further has a roller connected between the main body and the movable part.

19. The optical system as claimed in claim 17, wherein the first optical unit includes an optical lens, and the second optical unit includes at least an aperture blade pivotally connected to the main body and the movable part.

20. The optical system as claimed in claim 19, wherein the first optical unit extends into and connects to the main body.
